(19) United States
(12) Patent Application Publication
(10) Pub. No.: US 2026/0160331 A1
(43) Pub. Date: Jun. 11, 2026

(54) Dual-Component Ring Seal for Gland of Hydraulic Piston

(71) Applicant: Specialized Seal Design and Distribution, Inc., Houston, TX (US)

(72) Inventors: Geoffrey G. Boughton, Weston Lakes, TX (US); Larry Cobb, Canyon Lake, TX (US); Evan Coombs, Salt Lake City, UT (US); Stephen Armstrong, Salt Lake City, UT (US)

(21) Appl. No.: 19/414,082

(22) Filed: Dec. 9, 2025

Related U.S. Application Data
(60) Provisional application No. 63/729,924, filed on Dec. 9, 2024.

(51) Int. Cl. F16J 9/20; F16J 9/28

(52) U.S. Cl. CPC F16J 9/20; F16J 9/28

(57) ABSTRACT

A ring seal, which can be used in a gland of a hydraulic piston or pneumatic actuator, has two portions or rings molded together. A base portion or ring is composed of a first elastomeric material having a first hardness. A top surface of the base ring defines a slot. A crown ring or portion composed of a second elastomeric material having a second hardness is molded onto the top surface of the base ring. A bottom surface of the crown ring is molded to the base's top surface so that a rib is disposed in the slot of the base's top surface. The crown ring includes inside and outside flares extending respectively inward in and outward from the circumference of the ring seal at top corners. A recess is defined in the crown ring's top surface between the flares, and an annex is raised in the recess.

### CROSS-REFERENCE TO RELATED APPLICATIONS

This application claims the benefit of U.S. Provisional Appl. No. 63/729,924 filed Dec. 9, 2025, which is incorporated herein by reference in its entirety.

### BACKGROUND OF THE DISCLOSURE

Seals are used in equipment for many industries. For example, fluid power seals are used in equipment for hydraulic and pneumatic applications, especially in applications that require consistent pressure and control, like hydraulic pistons or pneumatic actuators in industrial and heavy machinery. Different fluid power seals include rod seals, piston seals, wipers, O-ring seals, and the likes, which can be used in conjunction with wear rings, bearings, backup rings, and the like.

For example, FIG. 1A illustrates an example of a rod seal 30 according to the prior art being used on a rod gland 10, which is shown in partial cutaway. FIG. 1B illustrates the example of the rod seal 30 according to the prior art in additional detail.

A rod 12b for the equipment, such as a hydraulic piston, passes through a bore 14 in the piston gland's body 12a. The rod seal 30 is positioned in an inner groove 16 of the piston gland's bore 14 and engages the rod 12b. The rod seal 30 reduces leakage by keeping fluid confined to defined areas, which prevents energy losses from leaks in hydraulic and pneumatic systems. To do this, the rod seal 30 can create a seal to contain fluid pressures, reduce friction, and keep out contaminants. The rod seal 30 can be composed of plastic, rubber, and PTFE materials and can be configured for different sealing needs, shock-load resistance, friction, and the like. Other elements used on the rod gland 10 can include a wiper 20 and a wear bushing 22.

The rod seal 30, shown isolated in FIG. 1B, includes a base ring 32 and an O-ring 34. The base ring 32 has a rectangular cross-section with the O-ring 34 installed in a circumferential slot of the base ring 32. The O-ring 34 energizes the rod seal 30 by functioning as a spring to maintain sealing contact even in low pressure or vacuum conditions. A beveled lip 33a provided on the base ring 32 can wipe any fluid film, and a stabilizing lip 33b can be provided on the base ring 32 to improve the fit of the rod seal 30 in the rod gland 10.

Although existing seals are effective, equipment manufacturers are always seeking improvements. For example, equipment manufacturers are interested in sealing across larger gaps, increasing resistance of seals to extrusion, simplifying installation of seals, and reducing abrasive qualities of seals.

The subject matter of the present disclosure is directed to overcoming, or at least reducing the effects of, one or more of the problems set forth above.

### BRIEF DESCRIPTION OF DRAWINGS

FIG. 1A illustrates an example of a rod seal according to the prior art used on a rod gland, shown in partial cutaway.

FIG. 1B illustrates the example of the rod seal according to the prior art in additional detail.

FIG. 2 illustrates a sealing element according to the present disclosure for use as a rod seal.

FIG. 3A illustrates a perspective view of the disclosed sealing element.

FIG. 3B illustrates a plan view of the disclosed sealing element.

FIG. 3C illustrates a cross-sectional view of the disclosed sealing element.

FIG. 4 illustrates a detailed cross-section of the disclosed sealing element.

FIG. 5A illustrates an example of the disclosed sealing element used as a piston seal on a piston gland, shown in partial cutaway.

FIG. 5B illustrates the disclosed sealing element as a piston seal.

FIG. 6 illustrates a process to form the disclosed sealing element.

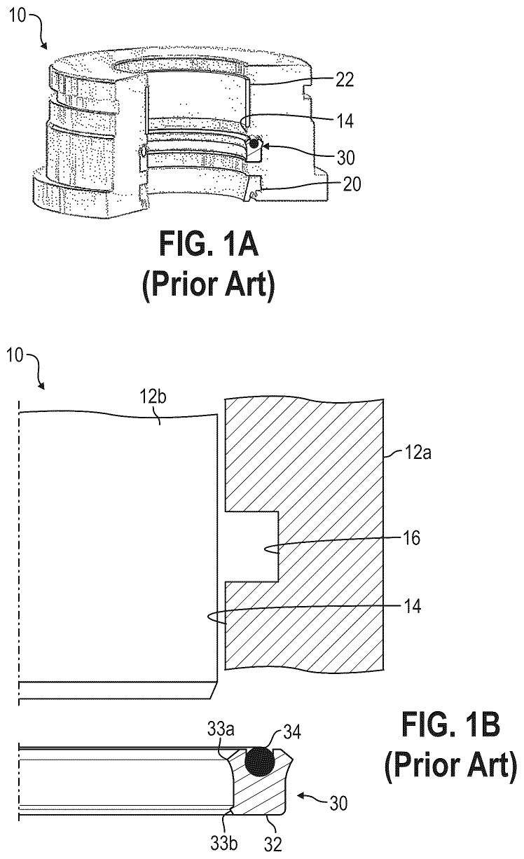

### DETAILED DESCRIPTION OF THE DISCLOSURE

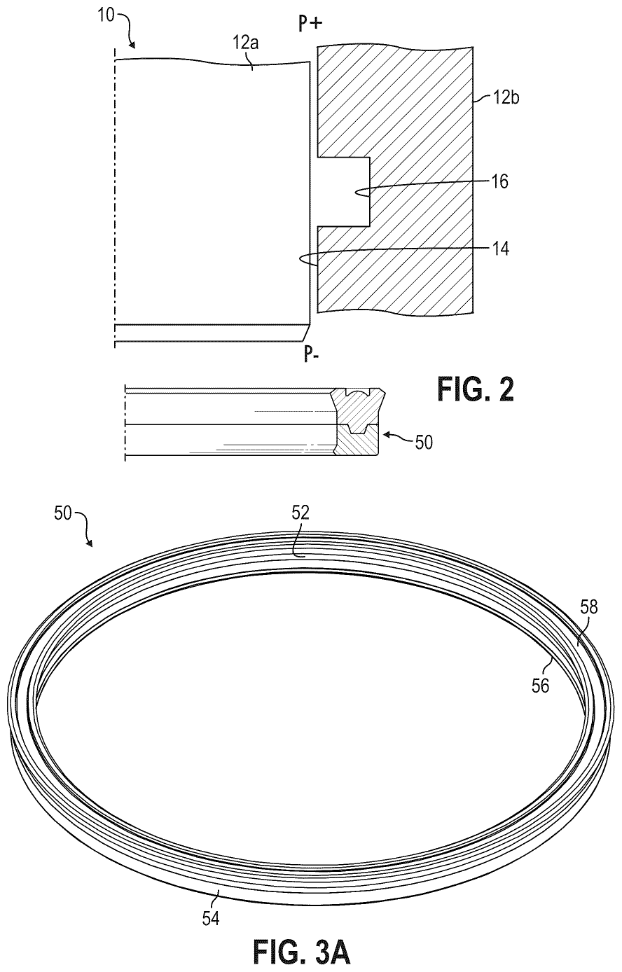

FIG. 2 illustrates a sealing element 50 according to the present disclosure. In general, the sealing element 50 is a ring seal configured to seal a gap between an inner component 12a disposed inside an outer component 12b. The ring seal 50, shown in isolation here, is configured to position in a groove 16 defined in one of the components 12b and configured to seal with the other component 12a. In this example, the ring seal 50 is shown here for use as a rod seal configured to position in a groove 16 defined in a bore 14 of a rod gland (i.e., outer component) 12b. The ring seal 50 seals with a rod (i.e., inner component) 12a. In general, the rod 12a and the rod gland 12b may be part of a hydraulic piston or a pneumatic actuator 10 used in industrial and heavy machinery, and the rod 12a moves axially inside the bore 14 of the rod gland 12a during operation.

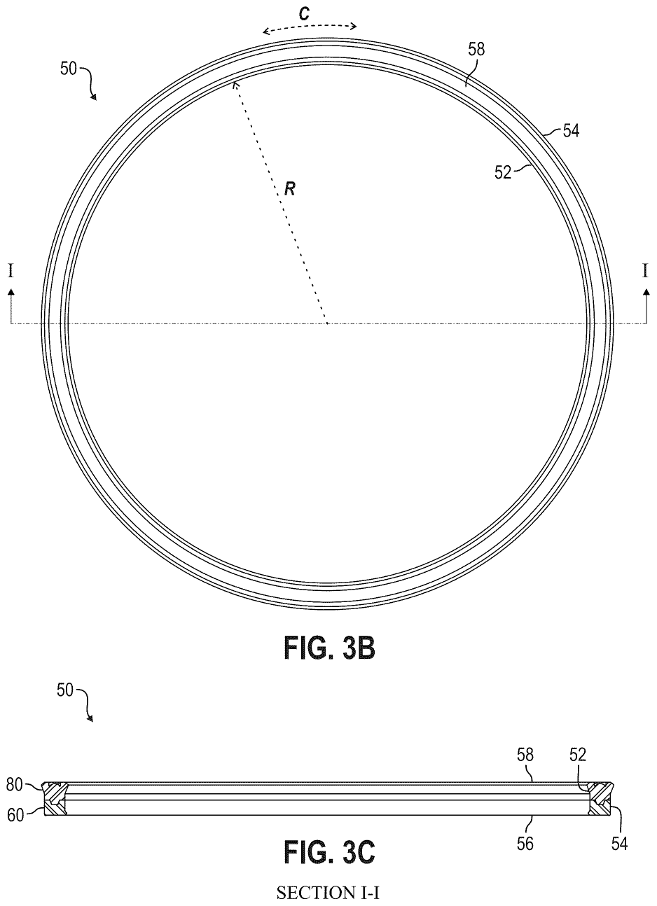

Looking at the ring seal 50 in more detail, FIG. 3A illustrates a perspective view of the ring seal 50, FIG. 3B illustrates a plan view of the ring seal 50, and FIG. 3C illustrates a cross-sectional view of the ring seal 50. The ring seal 50 has a radius R and defines a circumference C.

The ring seal 50 can be used as a rod seal or as a piston seal. In this example, the ring seal 50 is shown as a rod seal. The ring seal 50 has an inside surface 52 and an outside surface 54 defined about the circumference C of the ring seal 50. The ring seal 50 also has a “base” or “bottom” 56 and a “crown” or “top” 58. As will be appreciated, “base,” “bottom,” “crown,” “top,” and the like are relative terms and are merely used for explanation, as the ring seal 50 can be used in any orientation. When positioned in the groove (16) of a rod gland (12a) as in FIG. 2, the inside surface 52 of the ring seal 50 engages with the rod (12a), and the outside surface 54 engages with the groove (16). The “crown” 58 can position toward a positive pressure side (P+)—namely the high-pressure volume in a cylinder of the piston (10) having hydraulic fluid or compressed air. The “base” 58 can position toward a negative pressure side (P−)—namely the low-pressure (atmospheric) volume in the cylinder of the piston (10).

As best shown in FIG. 3C, the ring seal 50 is composed of two portions, elements, or rings 60, 80 fused, affixed, or molded together to make a composite ring body or a dual component body for the ring seal 50. One ring 60 is a “base” ring or portion defined about the circumference of the ring seal 50, and other ring 80 is a “crown” ring or portion defined about the circumference. Again, reference to “base” and “crown” are relative terms merely used for explanation, as the seal ring 50 can have any orientation.

The base ring 60 is composed of a first elastomeric material having one or more first properties, such as a first hardness. Meanwhile, the crown ring 80 is composed of a second elastomeric material having one or more second properties, such as a second hardness. The first and second properties are different as discussed below.

In one configuration, the base ring 60 can be composed of a thermoplastic elastomer material, such as a Thermoplastic Polyurethane (TPU), another type of polyurethane elastomer, a cast polyurethane (CPU), another type of urethane elastomer, Styrenic block copolymers (TPE-S), Thermoplastic polyester elastomer (TPE-E), Olefinic elastomers (TPE-O), or another thermoplastic material. Particular examples include P4304D60 TPU and P4313D65 TPU available from Parker Hannifin Corporation.

The base ring 60 composed of TPU can be flexible and elastic, allowing the base ring 60 to stretch and then return to its original shape when stress is removed. The TPU base ring 60 can resist abrasion, impacts, and wear. As will be appreciated, the hardness (e.g., Shore A scale or Shore D scale) of the TPU base ring 60 would vary depending on its specific formulation, but the hardness can generally range from about 70 to 95 Shore A (about 70 to 100 Rockwell scale R) to about 40 to 75 (about 20 to 70 Rockwell scale M). Preferably, the first hardness of the first elastomeric material for the base ring 60 can be between 55 to 70 Shore D or about 60 to 65 Shore D.

The crown ring 80 can be composed of a thermoset elastomer, such as nitrile rubber, Hydrogenated Nitrile Butadiene Rubber (HNBR), a Fluorocarbon (FKM) elastomer, Perfluoroelastomer (FFKM), or another thermoset elastomer. A particular example is N4007A95 HNBR from Parker Hannifin Corporation. The crown ring 80 composed of a specialized elastomer material, such as HNBR, can resist high-temperature and harsh chemical environments.

The crown ring 80 composed of HNBR has durability and resilience. For example, the crown ring 80 composed of HNBR can be elastic, allowing it to stretch and then recover its shape. The hydrogenation process increases the HNBR's resistance to heat, oil, chemicals, and environmental factors, so the crown ring 80 composed of HNBR can withstand harsh conditions and exposure to oils or chemicals. As will be appreciated, the hardness (e.g., Shore A scale) of the crown ring 80 composed of HNBR can vary depending on its specific formulation, but the hardness can range from about 75 Shore A to 95 Shore A. Preferably, the second hardness of the second elastomeric material for the crown ring 80 can be between 85 Shore A and 95 Shore A.

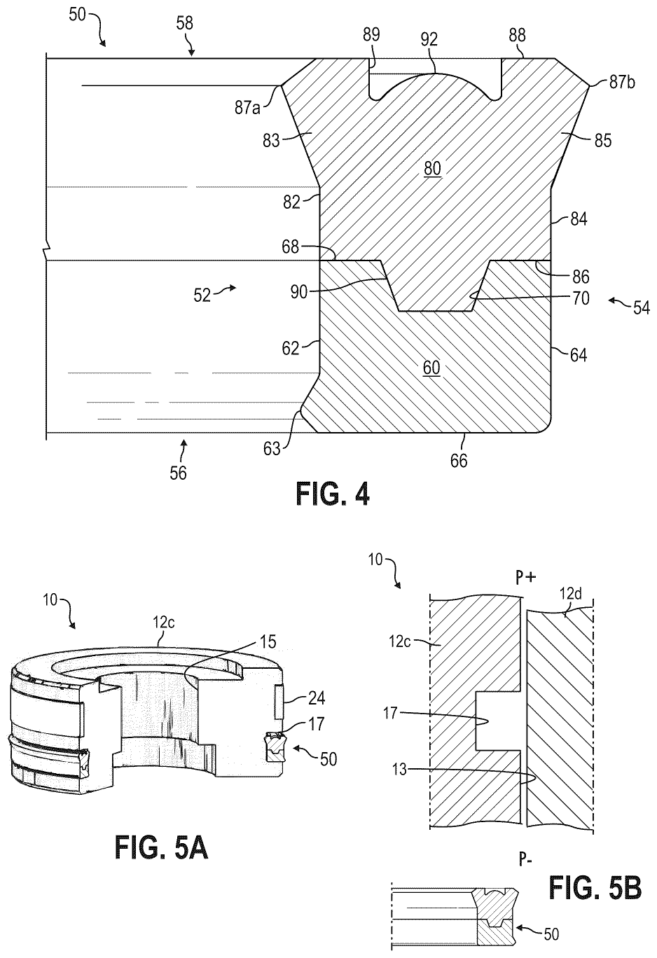

Looking at the mechanical structure of the ring seal 50 in more detail, FIG. 4 illustrates a detailed cross-section of the ring seal 50. The base ring 60 (or portion) defines a first inside section 62 of the ring seal's inside surface 52 and defines a first outside section 64 of the ring seal's outside surface 54. The base ring 60 has a first “bottom” surface 66 and has a first “top” surface 68. The first bottom surface 66 is generally flat to engage a shoulder of a groove (not shown) in which the ring seal 50 is position. The first “top” surface 68 defines a slot 70.

The crown ring 80 (or portion) of the ring seal 50 defines a second inside section 82 of the ring seal's inside surface 52 and defines a second outside section 84 of the ring seal's outside surface 54. The top ring 80 has a second “bottom” surface 86 and has a second “top” surface 88. The second bottom surface 86 surface is fused, affixed, or molded to the first top surface 68 of the base ring 60 so that the top's second bottom surface 86 has a rib 90 disposed in (molded into) the slot 70 of the base's first top surface 68.

The crown ring 80 has an inside flare 83 and an outside flare 85. The inside flare 83 extends inward in the circumference of the ring seal 50 at a top inside corner at the second inside section 82. Meanwhile, the outside flare 85 extends outward from the circumference of the ring seal 50 at a top outside corner at the second outside section 84. A recess 89 is defined in the second top surface 88 between the inside flare 83 and the outside flare 85, and an annex 92 is raised in the recess 90.

The flares 83, 85 and the recess 89 can be energized by fluid pressure from the high-pressure volume of the piston (10). As an option, a beveled lip 87a provided on the inside flare 83 can wipe any fluid film on the component (e.g., rod 12a) against which the ring seal 50 engaged. Additionally, a stabilizing lip 63 can be provided on the base ring 60 to improve a stable fit of the ring seal 50 in its groove. Furthermore, the lips 87a and 63 extending inward in the circumference of the ring seal 50 can keep debris from getting trapped between the ring seal 50 and the sealing surface.

The slot 70 defined in the first top surface 68 can define a rectilinear profile so that the rib 90 has a complementary profile engaged in the rectilinear profile. As shown here, the rectilinear profile of the slot 70 can be trapezoidal. The slot 70 and the rib 90 are configured to provide more surface area to keep the two rings 60, 80 molded together and to prevent shearing of one ring 60 from the other ring 80.

For its part, the annex 92 can define a curved profile rising in the recess 89 from the inside and outside flares 83, 85 toward a raised central portion. As shown here, the curved profile of the annex 92 can be circumferential. The annex 92 can bias the flares 83, 84 outward to maintain sealing contact with adjacent surfaces.

As can be seen, the disclosed seal ring 50 is an extrusion-resistant, “one-piece” or integrated seal having dual compounds (materials) molded together as base and crown rings or portions 60, 80 to respond as one unified sealing element. This seal ring 50 can be installed and removed from service as one piece. Compared to a two-piece seal having separate pieces, the one-piece seal ring 50 does not require assembly to be installed, which would complicate installation and increase the possibility of mistakes during installation.

The seal ring 50 can seal much larger extrusion gaps and can preferably pass qualifications of API 16 Third Edition “Annex A” part for non-metallic seal qualification. As the pressure connections age and begin to wear, for instance, the gap tolerances grow. The seal ring 50 can extend the life of the equipment by sealing in larger extrusion gaps before the equipment needs to be taken out of service to replace the seal ring 50. This will reduce costs. Additionally, the seal ring 50 does not have abrasive qualities, such as found with hard Polyether Ether Ketone (PEEK) or other similar materials, which can trap contaminants and damage the sealing surfaces over time.

As noted above, the ring seal 50 of the present disclosure can be used as a rod seal, being disposed in a groove of a rod gland or the like of a hydraulic piston or pneumatic actuator (10). The disclosed ring seal 50 can also be used in an alternative arrangement in which the ring seal 50 is configured to position in a groove of an inner component (e.g., a piston gland) and to seal against an outer component (e.g., a cylinder) of a hydraulic piston or pneumatic actuator (10). The features on the inner and outer circumferential surfaces 52, 54 of the ring seal 50 may simply be reversed for such an alternative arrangement.

For example, FIGS. 5A-5B illustrate an example of the disclosed ring seal 50 used as a piston seal on a piston gland 12c of a hydraulic piston or pneumatic actuator 10. In FIG. 5A, the piston gland 12c is shown in partial cutaway. The piston gland 12c defines a central opening 15 and affixed on a piston rod (not shown).

In general, the ring seal 50 is configured to seal a gap between the inner component (i.e., piston gland) 12c disposed inside an outer component (i.e., cylinder) 12d. The piston gland 12c (mounted on a rod) and the cylinder 12d may be part of a hydraulic piston or a pneumatic actuator 10 used in industrial and heavy machinery, and the piston gland 12c moves axially inside the cylinder 12d during operation. The ring seal 50, shown in isolation in FIG. 5B, is configured to position in a groove 17 defined on the outside surface 13 of the piston gland 12c. (Other components can be used on the piston gland, such as a bushing 24 shown in FIG. 5A.) The ring seal 50 seals with the inside surface of the cylinder 12d.

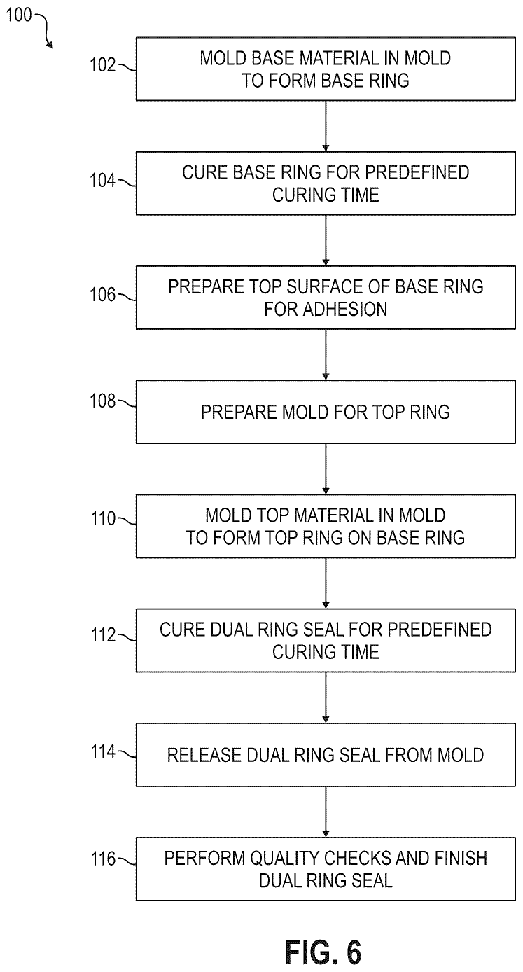

FIG. 6 illustrates a process 100 to form the disclosed ring seal 50. As detailed below, the base ring 60 is molded and cured in an injection molding process. An adhesive is applied to the top surface 68 of the base ring 60. The crown ring 80 is then compression molded on top of the base ring 68, and the adhesive can help bond the rings 60, 80 into a complete unit as the disclosed ring seal 50.

In the process 100, one or more molds can be designed to mold the two-component ring seal 50. For example, cavities in a mold can allow for separate molding/injection of each material for the rings 60, 80 of the ring seal 50. The mold can be initially set up to form the base ring 60 and can be later adjusted to form (overmold) the crown ring 80 onto the base ring 60. Alternatively, two separate molds can be used, including an injection mold used for the base ring 60 and a compression mold used for the crown ring 80.

As disclosed herein, the ring seal 50 can be formed of a base ring 60 composed of a Thermoplastic Polyurethane (TPU) or another thermoplastic material, and the ring seal 50 can be formed of a crown ring 80 composed of a Hydrogenated Nitrile Butadiene Rubber (HNBR) or another thermoset material. The molding process 100 involves a multi-step molding that combines the techniques for both the thermoplastic (TPU) material and the thermoset (HNBR) material.

In the process 100, a mold is placed into a molding machine, and the base material for the base ring 60 is molded in the mold (Block 102). The base ring 60 is then allowed to solidify or “cure” according to the material used (Block 104). The mold may have a cooling feature to expedite the solidification or curing.

For the base material being a thermoplastic material, such as a Thermoplastic Polyurethane (TPU), the thermoplastic material is melted and injected into the mold (Block 102). The base material is then solidified by cooling in the mold to form the base ring 60 (Block 104). For example, the bulk thermoplastic elements are heated to a specific melting temperature in the molding machine, and the melted thermoplastic material is then injected into the mold under high pressure (Block 102). Once in the mold, the thermoplastic material begins to cool and solidify so the thermoplastic material regains its structure, solidifying into the molded shape for the base ring 60 (Block 104).

The temperatures and pressures used will vary based on the grade of the thermoplastic material and other parameters. In general, the melting temperature of the thermoplastic material, such as TPU, of the base ring 60 can be about 190° C. to 230° C. (374° F. to 446° F.), depending on the specific grade and hardness. The injection pressure can typically be between 70 MPa to 150 MPa (10,000 psi to 21,750 psi). The mold can be set to a temperature of about 20° C. to 50° C. (68° F. to 122° F.) to allow for rapid cooling. Higher mold temperatures can be used to enhance surface finish or to increase dimensional stability.

Once the base ring 60 has been formed, one or more surfaces of the base ring can be prepared (Block 106). For example, a surface preparation can be made to the top surface 68 of the base ring 60 to enhance adhesion with the material of the crown ring 80 to be molded thereon. For example, a plasma treatment or a corona treatment can be performed on the top surface 68, or a suitable primer can be applied to the top surface 68. The base ring 60 can also be cleaned to remove any release agents or the like.

To improve adhesion, for example, a plasma surface treatment can expose the base ring's top surface 68 to a plasma field of a highly energized gas (e.g., oxygen, nitrogen, or argon) that contains ions, electrons, and radicals. This plasma interacts with the top surface 68 to increase the surface energy for improved bonding. A corona surface treatment is a similar process in which a high-frequency electrical discharge (corona) can be applied to the top surface 68 of the base ring 60. Localized oxidation of ozone and other reactive species modify the surface energy to improve adhesion.

Additionally, to improve adhesion, an adhesive material can be applied to the top surface 68 of the base ring 60. As noted above, the adhesive material can help bond the crown ring 80 to the base ring 60. Different types of adhesive material can be used, such as solvent-based adhesives, reactive adhesives, hot-melt adhesives, or rubber-to-plastic adhesives based on the elastomeric materials used for the base ring 60 and crown ring 80. For example, the solvent-based adhesives can include a Polyurethane adhesive compatible with both HNBR and TPU or a Chlorinated Rubber adhesive. The reactive adhesives can include an epoxy adhesive or can include a two-part polyurethane adhesive configured for bonding between HNBR and TPU. The hot-melt adhesives can include a Thermoplastic Polyurethane (TPU)-Based Hot-Melt adhesive to chemically bond with TPU and adhere with HNBR. Finally, the rubber-to-plastic adhesives can include a hybrid adhesive of Silane-Modified Polymer (SMP) that can bond rubber and plastic or can include a structural-grade acrylic adhesive for bonding. These and other adhesives can be used based on the implementation, and the particular composition of the adhesive can be configured to meet the desired specifications.

The mold is then prepared for molding of the crown ring 80 onto the base ring 60 (Block 108). To do this, the mold can be adjusted to accommodate the crown ring 80. For example, the components of the mold can be moved to allow a second cavity for the crown ring 80 to align directly above the formed base ring 60. The mold can be a two-shot or two-stage mold that allows the top material to be injected on top of the base ring 60, or the base ring 60 can remain in the same mold should the mold be designed for overmolding.

The thermoset material for the crown ring 80 is then molded directly onto the top surface 68 of the base ring 60 (Block 110). The thermoset material is molded at a temperature and a pressure that facilitates bonding with the base ring 60. The dual component ring seal 50 is then cured fully within the mold (Block 112). This may require maintaining proper temperature and pressure to avoid separation or weak adhesion.

For the crown ring 80 as a thermoset elastomer, such as Hydrogenated Nitrile Butadiene Rubber (HNBR), the thermoset material undergoes a curing process (vulcanization) in the mold. As a thermoset elastomer, for example, the HNBR material requires a curing process (vulcanization) to set its shape permanently. Once cured, the HNBR material cannot be melted and reshaped, unlike the TPU material of the base ring 60.

To start the thermoset process, a compound material having the HNBR material mixed with curing agents and other additives is formed before being introduced to the mold. The material can then be placed in the mold cavity (Block 110). For example, the material may be placed by compression or transfer molding. Alternatively, the compound can be injection molded when the mold and the molding machine are configured for elastomer processing.

Once the material is in the mold, a compression molding process can be used in which heat and pressure initiate the vulcanization process to cure the material for the crown ring 80 (Block 112). Because the base ring 60 is composed of a thermoplastic elastomer (TPE), such as TPU, the base ring 60 can be molded and remolded without requiring curing so the base ring 60 can be exposed to the heat and pressure during the vulcanization process used to cure the thermoset material of the crown ring 80.

During vulcanization, cross-linking occurs, transforming the HNBR material into a solid, elastic material with the defined mechanical properties. As will be appreciated, the curing time varies based on the specific formulation, curing temperature, and other parameters. However, the temperature during the curing phase of the thermoset material of the crown ring 80 can be controlled to maintain an adequate mold temperature while ensuring good bonding occurs between the interface of the two materials without affecting the integrity of the material of the base ring 60.

After the crown ring's thermoset material has been fully cured, the thermoset material is cooled slightly in the mold. The curing temperature for the HNBR material of the crown ring 80 can range from about 160° C. to 180° C. (320° F. to 356° F.) so efficient cross-linking can occur, but higher or lower temperatures may be used depending on the formulation. The curing pressure for the HNBR material of the crown ring 80 can range from about 3.5 MPa to 10 MPa (500 psi to 1,450 psi) to ensure the material fills the mold cavity and adheres to the base ring 60. Generally, the curing time can range from 5 to 30 minutes, depending on part thickness and mold design.

Once curing is complete and both rings 60, 80 have solidified and bonded as intended, the mold is opened to remove the ring seal 50 (Block 114). The dual component ring seal 50 can be inspected for proper bonding and alignment of both rings 60, 80, and tests can be performed to ensure the adhesion and structural integrity meet specifications (Block 116). Any additional finishing, such as flash removal, machining, cutting, coating, and the like can then be performed to prepare the dual ring seal 50 for use.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A ring seal defining a circumference and comprising:
an inside surface defined about the circumference;
an outside surface defined about the circumference;
a base ring defined about the circumference, the base ring being composed of a first elastomeric material having a first hardness, the base ring defining a first inside section of the inside surface on the ring seal and defining a first outside section of the outside surface on the ring seal, the base ring having a first bottom surface and a first top surface, the first top surface defining a slot;
a crown ring defined about the circumference, the crown ring being composed of a second elastomeric material having a second hardness, the second elastomeric material being different than the first elastomeric material, the crown ring defining a second inside section of the inside surface on the ring seal and defining a second outside section of the outside surface on the ring seal, the crown ring having a second bottom surface and a second top surface, the second bottom surface having a rib disposed in the slot of the first top surface, the second bottom surface attached to the first top surface,
wherein the crown ring has:
an inside flare extending inward in the circumference of the ring seal at a top inside corner at the second inside section;
an outside flare extending outward from the circumference of the ring seal at a top outside corner at the second outside section;
a recess defined in the second top surface between the inside flare and the outside flare; and
an annex being raised in the recess.

2. The ring seal of claim 1, wherein the base ring defines a toe extending inward in the circumference of the ring seal at a bottom inside corner at the first inside section.

3. The ring seal of claim 1, wherein the annex defines a curved profile rising in the recess from the inside and outside flares toward a raised central portion.

4. The ring seal of claim 3, wherein the curved profile is circumferential.

5. The ring seal of claim 1, wherein the inside flare defines a sharp inside edge on the second inside section of the inside surface on the ring seal; and wherein the outside flare defines a sharp outside edge on the second outside section of the outside surface on the ring seal.

6. The ring seal of claim 1, wherein the first elastomeric material comprises a thermoplastic material.

7. The ring seal of claim 6, wherein the thermoplastic material comprises a thermoplastic polyurethane.

8. The ring seal of claim 1, wherein the second elastomeric material comprises a thermoset material.

9. The ring seal of claim 8, wherein the thermoset material comprises a hydrogenated nitrile butadiene rubber.

10. The ring seal of claim 1, wherein the first hardness of the first elastomeric material is between 55 Shore D and 65 Shore D; and wherein the second hardness of the second elastomeric material is between 80 Shore A and 95 Shore A.

11. The ring seal of claim 1, wherein the slot defined in the first top surface defines a first rectilinear profile; and wherein the rib defines a second rectilinear profile configured to engage in the first rectilinear profile.

12. The ring seal of claim 11, wherein the first and second rectilinear profiles are trapezoidal.

13. The ring seal of claim 1, wherein the seal is configured to seal a gap between an inner component disposed inside an outer component, the seal being configured to position in a groove defined in at least one of the inner component and the outer component.

14. A method, comprising:
molding a base ring of a first elastomeric material with a first hardness for a ring seal by forming the base ring to have:
a first inside section of an inside surface on the seal,
a first outside section of an outside surface on the seal,
a first bottom surface, and
a first top surface defining a slot; and
molding a crown ring of a second elastomeric material with a second hardness onto the base ring for the ring seal by forming the crown ring to have:
a second inside section of the inside surface on the seal,
a second outside section of the outside surface on the seal,
a second bottom surface molded to the first top surface and having a rib disposed in the slot of the first top surface, and
a second top surface having:
an inside flare extending inward in a circumference of seal at a top inside corner at the second inside section;
an outside flare extending outward from the circumference of the seal at a top outside corner at the second outside section;
a recess defined in the second top surface between the inside flare and the outside flare; and
an annex being raised in the recess.

15. The method of claim 14, wherein molding the base ring of the first elastomeric material comprises injection molding the first elastomeric material comprising a thermoplastic material.

16. The method of claim 15, wherein molding the crown ring of the second elastomeric material comprises compression molding the second elastomeric material comprising a thermoset material.

17. The method of claim 16, wherein the thermoplastic material comprises a thermoplastic polyurethane; and wherein the thermoset material comprises a hydrogenated nitrile butadiene rubber.

18. The method of claim 14, wherein molding the crown ring of the second elastomeric material comprises applying an adhesive material to the first top surface of the base ring before molding the crown ring onto the base ring.

19. The method of claim 14, comprising preparing the first top surface of the base ring before molding the crown ring.

20. A ring seal formed by the method according to claim 14.
